(19) United States
(12) Patent Application Publication
(10) Pub. No.: US 2026/0364794 A1
(43) Pub. Date: Nov. 19, 2026

(54) TASK PLAN GENERATION METHOD AND MOBILE MANIPULATOR SYSTEM USING THE SAME

(71) Applicants: Samsung Display Co., Ltd., Yongin-si (KR); KOREA ADVANCED INSTITUTE OF SCIENCE AND TECHNOLOGY, Daejeon (KR)

(72) Inventors: Uitak YUN, Yongin-si (KR); Seokjoon KWON, Daejeon (KR); Dongeui CHANG, Daejeon (KR); Cheollae ROH, Yongin-si (KR); Jungkook JANG, Yongin-si (KR)

(73) Assignees: Samsung Display Co., Ltd., Yongin-si (KR); KOREA ADVANCED INSTITUTE OF SCIENCE AND TECHNOLOGY, Daejeon (KR)

(21) Appl. No.: 19/681,718

(22) Filed: May 19, 2026

(30) Foreign Application Priority Data
May 19, 2025 (KR) 10-2025-0064813

(51) Int. Cl. B25J 9/16; G06T 7/50

(52) U.S. Cl. CPC B25J 9/1661; B25J 9/162; B25J 9/1697; G06T 7/50; G06T 2207/10028

(57) ABSTRACT

Provided are a task plan generation method for a mobile manipulator, and a mobile manipulator system using the same. The task plan generation method may include obtaining an image, depth information, and a user command from an input module; generating a plurality of task plans, based on the image, the depth information, and the user command, a task plan of the plurality of task plans including sub-plans; calculating relevance scores of the plurality of task plans with respect to the user command; and selecting a final task plan from among the plurality of task plans based on the relevance scores.

### CROSS-REFERENCE TO RELATED APPLICATION

This application is based on and claims priority under 35 U.S.C. §119 to Korean Patent Application No. 10-2025-0064813, filed on May 19, 2025, in the Korean Intellectual Property Office, the disclosure of which is incorporated by reference herein in its entirety.

### BACKGROUND

### 1. Field

One or more embodiments relate to a task plan generation method and a mobile manipulator system using the same, and, more particularly, to a task plan generation method for a mobile manipulator to autonomously establish and perform a task plan based on a user command, and a mobile manipulator system using the same.

### 2. Description of the Related Art

Recently, mobile manipulators have been utilized in various fields such as logistics, manufacturing, services, and exploration, and their importance is increasing. In order for a mobile manipulator to autonomously establish and perform efficient task plans based on user commands in complex environments, advanced environment recognition technology and task planning technology are required.

Scene graph generation methods have been attracting attention as one of such environment perception (or recognition) technologies. A scene graph represents objects present in an image as nodes, and expresses relationships or attributes between these objects as edges that connect the nodes. Accordingly, it becomes possible to structurally comprehend not just information about the presence or positions of objects, but also spatial and semantic relationships between the objects.

However, related art task plan generation methods have a problem in that it is difficult to process an abstract user command in which a target object and a target position are not clear.

### SUMMARY

One or more embodiments include a task plan generation method by which a mobile manipulator can autonomously generate and perform a task plan even based on an abstract user command, and a mobile manipulator system using the same. However, the embodiments are only examples, and the scope of the disclosure is not limited thereto.

Additional aspects will be set forth in part in the description which follows and, in part, will be apparent from the description, or may be learned by practice of the presented embodiments of the disclosure.

According to an aspect of one or more embodiments, provided is a task plan generation method for a mobile manipulator including: obtaining an image, depth information, and a user command from an input module; generating a plurality of task plans, based on the image, the depth information, and the user command, a task plan of the plurality of task plans including sub-plans; calculating relevance scores of the plurality of task plans with respect to the user command; and selecting a final task plan from among the plurality of task plans based on the relevance scores.

According to an aspect of one or more embodiments, provided is a mobile manipulator system including an input module configured to obtain an image, depth information, and a user command; a task plan module configured to generate a plurality of task plans, based on the image, the depth information, and the user command, a task plan of the plurality of task plans including sub-plans; calculate relevance scores of the plurality of task plans with respect to the user command; and select a final task plan from among the plurality of task plans based on the relevance scores; and a manipulator configured to perform the user command according to the final task plan.

Other aspects, features, and advantages other than those described above will become apparent from the following drawings, claims, and detailed description of the disclosure.

These general and specific aspects may be practiced by using systems, methods, computer programs, or any combination of systems, methods, and computer programs.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram schematically showing a mobile manipulator system according to an embodiment;

FIG. 2 is a flowchart schematically showing a task plan generation method according to an embodiment;

FIG. 3 is a flowchart schematically showing an operation of generating a scene graph, according to an embodiment;

FIG. 4 is a flowchart schematically showing an operation of generating an object node, according to an embodiment;

FIG. 5 is a diagram for schematically explaining object nodes according to an embodiment;

FIG. 6 is a graph for schematically explaining object nodes according to an embodiment;

FIG. 7 is a flowchart schematically showing an operation of generating a workspace list, according to an embodiment;

FIG. 8 is a diagram for schematically explaining an operation of generating a workspace list, according to an embodiment;

FIG. 9 is a flowchart for schematically explaining an operation of generating workspace nodes, according to an embodiment;

FIGS. 10 and 11 are each a diagram for schematically explaining an operation of generating workspace nodes, according to an embodiment;

FIG. 12 is a graph for schematically explaining workspace nodes according to an embodiment;

FIG. 13 is a flowchart schematically showing an operation of generating a partial scene graph, according to an embodiment;

FIG. 14 is a diagram for schematically explaining an operation of generating an edge between an object and a workspace, according to an embodiment;

FIG. 15 is a graph for schematically explaining a partial scene graph according to an embodiment;

FIG. 16 is a flowchart schematically showing an operation of producing a scene graph, according to an embodiment;

FIG. 17 is a flowchart schematically showing an operation of a task plan generation module, according to an embodiment;

FIG. 18 is a diagram schematically explaining an operation of generating a plurality of task plans by using a large language model, according to an embodiment;

FIG. 19 is a diagram for schematically explaining an operation of selecting a final task plan, according to an embodiment;

FIG. 20 is a diagram schematically explaining an operation of performing a final task plan, according to an embodiment; and

FIG. 21 is a block diagram schematically showing a mobile manipulator system according to an embodiment.

### DETAILED DESCRIPTION

Reference will now be made in detail to embodiments, examples of which are illustrated in the accompanying drawings, wherein like reference numerals refer to like elements throughout the specification. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

Various modifications may be applied to the present embodiments, and particular embodiments will be illustrated in the drawings and described in the detailed description section. The effect and features of the disclosure, and a method to achieve the same, will be clearer referring to the detailed descriptions below with the drawings. However, the present embodiments may be implemented in various forms, not by being limited to the embodiments presented below.

Hereinafter, embodiments of the disclosure will be described in detail with reference to the accompanying drawings, and in the description with reference to the drawings, the same or corresponding components are indicated by the same reference numerals and redundant descriptions thereof are omitted.

In the present specification, the expression of singularity in the present specification includes the expression of plurality unless clearly specified otherwise in context.

In the present specification, it will be further understood that the terms “comprises” and/or “comprising” used herein specify the presence of stated features or components, but do not preclude the presence or addition of one or more other features or components.

In the present specification, when a certain embodiment may be implemented differently, a specific process order may be performed differently from the described order. For example, two consecutively described processes may be performed substantially at the same time or performed in an order opposite to the described order.

In the present specification, the term “module” may refer to a software component and/or a hardware component that performs a specific function. The software component or the hardware component may correspond to one or more “modules.” Likewise, a single “module” may include one or more software components and/or one or more hardware components. The hardware component may include memory, a logic element, a gate array, a microprocessor, a microcontroller, a central processing unit, or an electronic control unit. The software component may refer to executable code and/or data used by the executable code stored in an addressable storage medium. The software components may be, for example, object-oriented software components, class components, and task components, and may include processes, functions, procedures, sub-routines, program code segments, drivers, firmware, microcode, circuits, data, databases, data structures, tables, arrays, or variables.

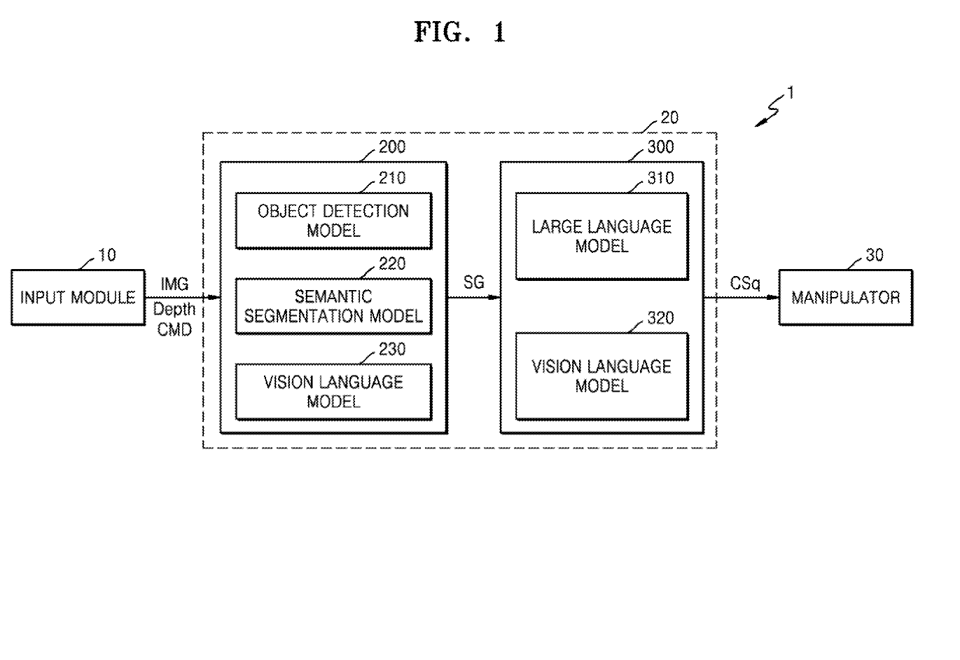

FIG. 1 is a block diagram schematically showing a mobile manipulator system according to an embodiment.

Referring to FIG. 1, a mobile manipulator system 1 according to an embodiment may include an input module 10, a task plan module 20, and a manipulator 30.

The mobile manipulator system 1 may obtain a user command CMD and environment information including an image IMG and depth information Depth through the input module 10, autonomously establish a task plan for the user command CMD by using the task plan module 20, and control the manipulator 30 to perform the task plan.

The input module 10 may collect the environment information including the image IMG and the depth information Depth, receive the user command CMD, and provide the environment information and the user command CMD to the task plan module 20. The input module 10 may include an input device such as, for example but not limited to, a physical button, a keyboard and/or a microphone for receiving the user command CMD. In addition, the input module 10 may include an RGB-D camera that obtains the image IMG and the depth information Depth, and/or may include an RGB camera or a Light Detection and Ranging (LiDAR) sensor. Alternatively or additionally, the input module 10 may include various sensor modules such as, for example but not limited to, a touch sensor, a pressure sensor, a distance sensor, a location sensor, a digitizer, a motion recognition sensor, a light-receiving sensor, a photoelectric conversion sensor, and a temperature sensor. In an embodiment, the input module 10 may be attached to a mobile device and obtain environment information while moving to various locations.

The task plan module 20 may include a scene graph generation module 200 and a task plan generation module 300. The scene graph generation module 200 may be configured to generate a scene graph SG having a hierarchical structure that may include a room, workspaces, and objects, based on the image IMG, the depth information Depth, and the user command CMD, which are received from the input module 10. The task plan generation module 300 may be configured to generate a plurality of task plans, based on the user command CMD and the scene graph SG generated by the scene graph generation module 200, and to select a final task plan that best matches the user command CMD among the plurality of task plans.

The scene graph generation module 200 may include an object detection model 210, a semantic segmentation model 220, and a vision language model 230. The object detection model 210 may be an artificial intelligence model that identifies positions and types of the objects within the image IMG, generates bounding boxes respectively corresponding to the objects within the image IMG, and assigns labels. The object detection model 210 may be configured to detect the objects within the room, based on the image IMG and the depth information Depth, which are received from the input module 10, and to generate an object node for each of the detected objects.

The vision language model 230 may be an artificial intelligence model that combines visual information, such as the image IMG, with text to perform visual question answering related to the image IMG. The vision language model 230 may be configured to generate a list of workspaces (or a workspace list) for the object nodes and generate visual information including a visual feature vector for each of workspaces.

The semantic segmentation model 220 may be an artificial intelligence model that segments the image IMG at a pixel level according to a precise shape and a boundary of an object. The semantic segmentation model 220 may be configured to extract pixels corresponding to each of the workspaces from the image IMG and the depth information Depth, based on the workspace list generated by the vision language model 230, and to generate a bounding box for each of the workspaces.

The task plan generation module 300 may include a large language model 310 and a vision language model 320. The large language model 310 may be an artificial intelligence model that learns large-scale text data, understands patterns, contexts and meanings of words and sentences, and is capable of processing long and/or complex texts. The large language model 310 may be configured to generate a plurality of task plans based on the scene graph SG received from the scene graph generation module 200 and the user command CMD received from the input module 10, and to convert sub-plans of the final task plan into a code sequence CSq of robot control functions.

The vision language model 320 may be configured to calculate a relevance score of each of the plurality of task plans generated by the large language model 310 with respect to the user command CMD. In an embodiment, the vision language model 320 of the task plan generation module 300 may be a bootstrapping language-image pre-training (BLIP) model for extracting text feature vectors.

The manipulator 30 may be a part of a robot that performs a task plan generated by the task plan module 20 according to the user command CMD. In an embodiment, the manipulator 30 may be attached to a mobile device and perform the task plan while moving to various locations.

The mobile manipulator system 1 according to embodiments may enable an intelligent robot to successfully perform a task according to the user command CMD that includes abstract natural language. The scene graph generation module 200 of the mobile manipulator system 1 may generate a scene graph having a hierarchical structure including a room node, workspace nodes, object nodes, and edges connecting the object nodes, and transmit the scene graph to the task plan generation module 300. The task plan generation module 300 may understand abstract natural language, such as “same place,” “different place,” “repair tool,” or “writing instrument,” by using the large language model 310, and generate a task plan according to the user command CMD. Therefore, an intelligent robot using the mobile manipulator system 1 may autonomously perform tasks in various environments such as industrial sites and homes.

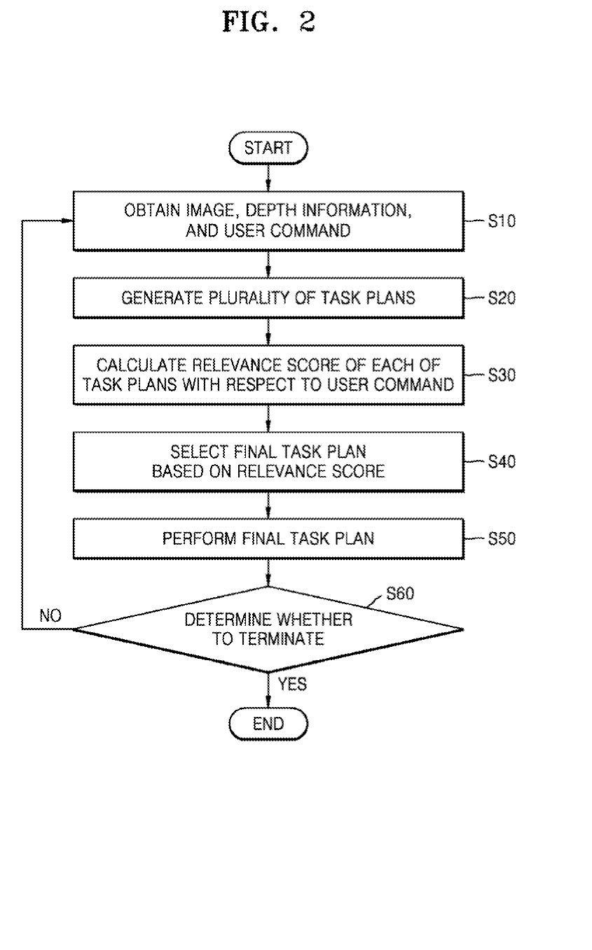

FIG. 2 is a flowchart schematically showing a task plan generation method according to an embodiment.

Referring to FIG. 2, the task plan generation method according to an embodiment may include obtaining an image, depth information, and a user command (operation S10), generating a plurality of task plans (operation S20), calculating a relevance score of each of the plurality of task plans with respect to the user command (operation S30), selecting a final task plan based on the relevance score (operation S40), performing the final task plan (operation S50), and determining whether to terminate task plan generation (operation S60).

In the obtaining of the image, the depth information, and the user command (operation S10), the mobile manipulator system 1 may obtain the image IMG, the depth information Depth, and the user command CMD from the input module 10.

The generating of the plurality of task plans (operation S20) may include an operation in which the scene graph generation module 200 generates the scene graph SG based on the image IMG and the depth information Depth, and an operation in which the task plan generation module 300 generates the plurality of task plans based on the scene graph SG and the user command CMD. Each of the plurality of task plans generated using the large language model 310 may include sub-plans based on natural language.

In the calculating of the relevance score of each of the task plans with respect to the user command (operation 30), the task plan generation module 300 may quantitatively compute a relevance score of each of sub-plans of a task plan with respect to the user command CMD, filter out sub-plans based on relevance scores thereof, and sum relevance scores of remaining sub-plans, thereby calculating the relevance score of a corresponding task plan of the plurality of task plans.

In the selecting of the final task plan based on the relevance score (operation S40), the task plan generation module 300 may select a task plan having a highest relevance score as the final task plan that best matches the user command CMD, by comparing the relevance scores of the plurality of task plans.

In the performing of the final task plan (operation S50), the task plan generation module 300 may convert the final task plan including natural language sentences into the code sequence CSq of robot control functions by using the large language model 310, and the manipulator 30 may operate according to the code sequence CSq.

In the determining of whether to terminate task plan generation (operation S60), the mobile manipulator system 1 may determine whether the task plan according to the user command CMD has been performed, and may terminate the system or switch to a standby mode when there is no new user command CMD received. In an embodiment, in a standby state where no user command CMD is input to the mobile manipulator system 1, the mobile manipulator system 1 may be configured to update the scene graph SG and the environment information including the image IMG and the depth information Depth at regular intervals.

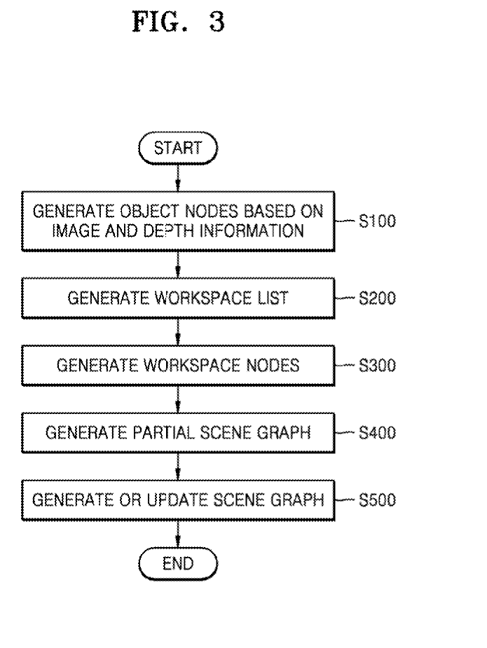

FIG. 3 is a flowchart schematically showing an operation of generating a scene graph, according to an embodiment.

Referring to FIG. 3, the generating of the scene graph SG according to an embodiment may include generating object nodes based on the image IMG and the depth information Depth (operation S100), generating a workspace list (operation S200), generating workspace nodes (operation S300), generating a partial scene graph (operation S400), and generating or updating the scene graph (operation S500).

In the generating of the object nodes based on the image IMG and the depth information Depth (operation S100), the scene graph generation module 200 may detect objects within the image IMG and generate an object node for each of the detected objects, by using the object detection model 210. Each of the object nodes may store visual information and positional information of a corresponding object. When two or more objects having the same label exist within one image IMG, it may be determined whether the two or more objects are the same object, and object nodes of the same object may be merged.

In the generating of the workspace list (operation S200), the scene graph generation module 200 may generate the workspace list by inputting an object detection image and a question prompt to the vision language model 230. In the present specification, the object detection image may include an image in which bounding boxes indicating positions and sizes of the objects within the image IMG are displayed by the object detection model 210. The vision language model 230 may recognize a workspace in which each object is located in the image IMG, and output a label of the workspace. The workspace list may include workspace labels output from the vision language model 230 based on workspaces in which respective objects are located in the image IMG.

In the generating of the workspace nodes (operation S300), the scene graph generation module 200 may extract pixels corresponding to each of workspaces of the workspace list within the image IMG and may generate a bounding box for each of the workspaces, by using the semantic segmentation model 220. The scene graph generation module 200 may generate a workspace node based on the extracted pixels and the bounding box.

In the generating of the partial scene graph (operation S400), the scene graph generation module 200 may assign object nodes as lower-level nodes of a corresponding workspace node, and may generate edges representing relationships between the object nodes and the workspace nodes. The partial scene graph may be generated based on the image IMG and the depth information Depth at a specific time point and a specific position, and may have three-level hierarchy including a room node, workspace nodes, and object nodes, wherein the room node, the workspace nodes, and the object nodes are connected through edges.

In the generating or updating of the scene graph (operation S500), the scene graph generation module 200 may generate a new scene graph based on the partial scene graph, or may update the scene graph by merging the partial scene graph with a scene graph up to a previous time point (hereinafter referred to as a previous scene graph). Each of the workspace nodes of the partial scene graph may be merged with a workspace node of the previous scene graph based on a similarity between the workspace nodes of the partial scene graph and the workspace nodes of the previous scene graph, or may be added as a new workspace node. The scene graph generation module 200 may update the scene graph by traversing all workspace nodes of the partial scene graph and either merging them with the workspace nodes of the previous scene graph or adding them as new workspace nodes.

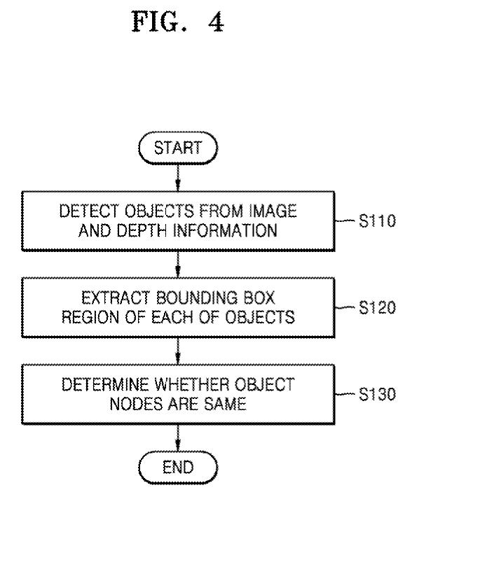

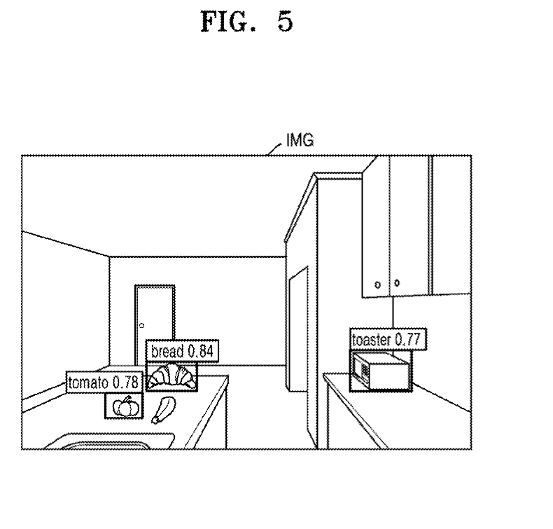

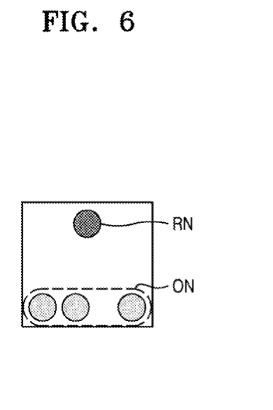

FIG. 4 is a flowchart schematically showing an operation of generating an object node, according to an embodiment. FIG. 5 is a diagram for schematically explaining object nodes according to an embodiment. FIG. 6 is a graph for schematically explaining object nodes according to an embodiment.

Referring to FIG. 4, the generating of the object nodes based on the image and the depth information (operation S100) of FIG. 3 may include detecting objects from the image and the depth information (operation S110), extracting a bounding box region of each of the objects (operation S120), and determining whether the object nodes are the same (operation S130).

In the detecting of the objects from the image and the depth information (operation S110), the scene graph generation module 200 may detect objects within the image IMG and may generate an object node for each of the objects, by using the object detection model 210. Referring to FIG. 5, the object detection model 210 may detect objects from the image IMG and display a label and a bounding box for each of the objects.

FIG. 6 shows, as an example, a room node RN and object nodes ON included in a scene graph. Referring to FIG. 6, the object nodes ON are lower-level nodes of the room node RN, and the object nodes ON may respectively correspond to the objects detected from the image IMG.

In the extracting of the bounding box region of each of the objects (operation S120), the scene graph generation module 200 may extract a portion corresponding to the bounding box region of each object from the image IMG and store the extracted portion in a corresponding object node, by using the object detection model 210. Each of the object nodes may store visual information and positional information together. The visual information may include a visual feature vector for a portion corresponding to a bounding box region, the visual feature vector being extracted by using a visual feature extractor. The positional information may include object coordinates based on a world coordinate system, wherein the object coordinates may be calculated by obtaining a point cloud corresponding to pixels within a bounding box, converting the point cloud into the world coordinate system considering a robot’s pose, and then averaging each of x, y, and z values of the converted point cloud.

In the determining of whether the object nodes are the same (operation S130), the scene graph generation module 200 may determine, when there are two or more objects having the same label within the image IMG, whether the two or more object nodes having the same label are the same, based on at least one of a visual similarity or a positional similarity. The visual similarity may be determined based on a cosine similarity between visual feature vectors stored in the object nodes, and the positional similarity may be determined based on distances between xyz coordinates of the object nodes. Objects having the same label, which have a high visual similarity, and have a high position similarity (that is, being sufficiently close to each other), are determined to be the same object and object nodes of these objects are merged, and when objects having the same label are determined to be different objects, independent object IDs may be assigned to object nodes of these objects to distinguish the objects as separate objects.

Finally, each object node may store the original image IMG from which a corresponding object has been detected, a portion corresponding to a bounding box region of the image IMG, xyxy coordinates of a bounding box, a visual feature vector, object coordinates based on the world coordinate system, and an object ID.

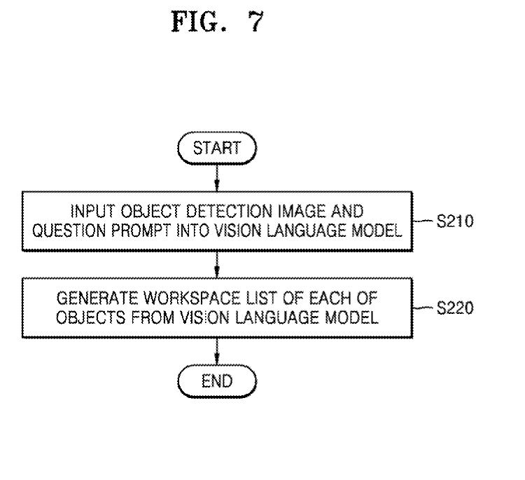

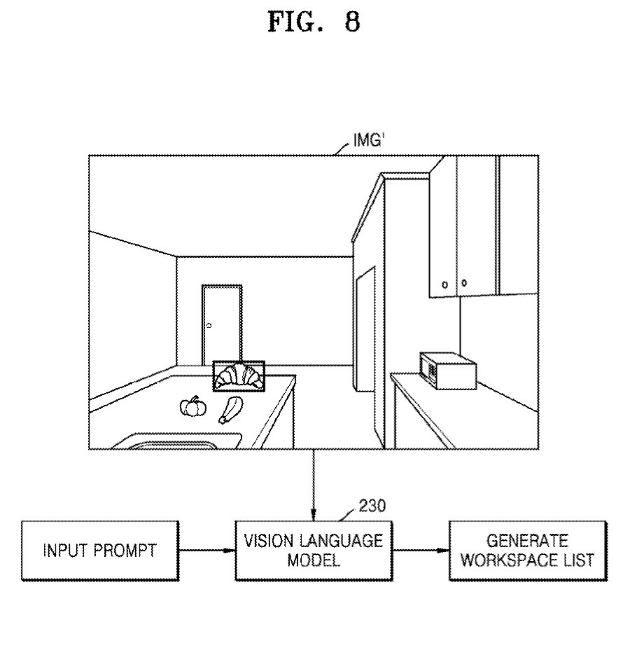

FIG. 7 is a flowchart schematically showing an operation of generating a workspace list, according to an embodiment. FIG. 8 is a diagram for schematically explaining an operation of generating a workspace list, according to an embodiment.

Referring to FIG. 7, the generating of the workspace list (operation S200) of FIG. 3 may include inputting an object detection image and a question prompt into a vision language model (operation S210), and generating the workspace list of objects from the vision language model (operation S220).

In the inputting of the object detection image and the question prompt into the vision language model (operation S210), the scene graph generation module 200 may sequentially select each object and input the object detection image and the question prompt corresponding to the selected object into the vision language model 230. The object detection image may be an image in which a bounding box of each object is displayed in the image IMG, and the question prompt may be a prompt asking where a workspace of each object is.

In the generating of the workspace list of the objects from the vision language model (operation S220), the scene graph generation module 200 may obtain a name of the workspace of each object and store names the workspaces of the objects as the workspace list.

Referring to FIG. 8, an object detection image IMG’ and a prompt for a selected object (e.g., bread) may be input to the vision language model 230. The prompt may be a question prompt asking where a workspace of the bread is. The vision language model 230 may generate a countertop as an answer, based on the object detection image IMG’ and the prompt. The scene graph generation module 200 may sequentially select each object and store a corresponding answer regarding the workspace of each object, thereby generating the workspace list.

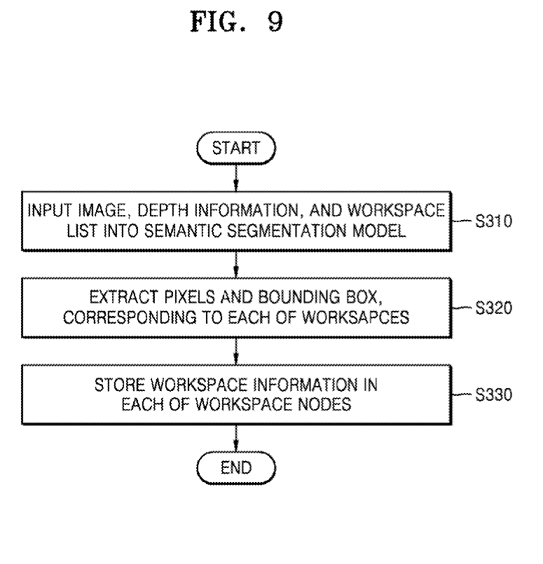

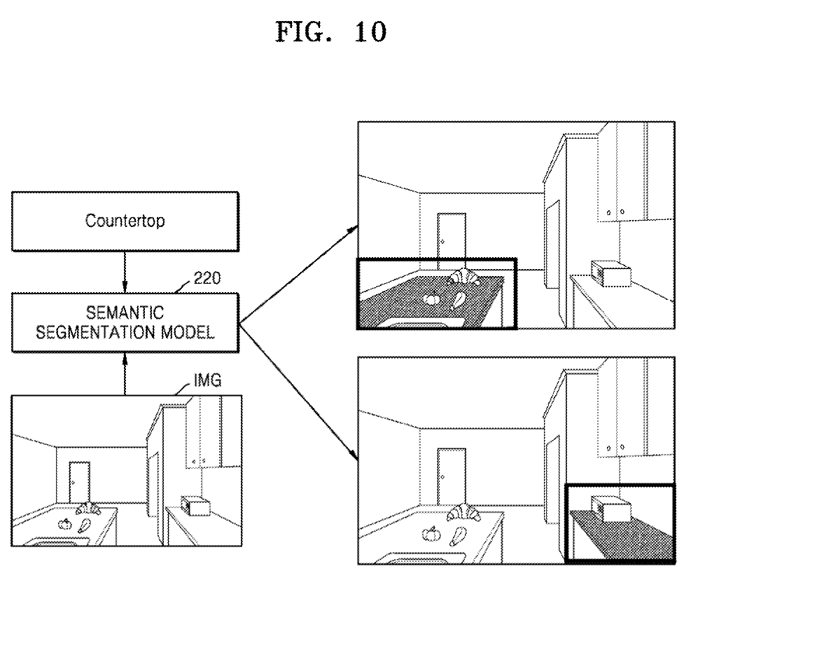

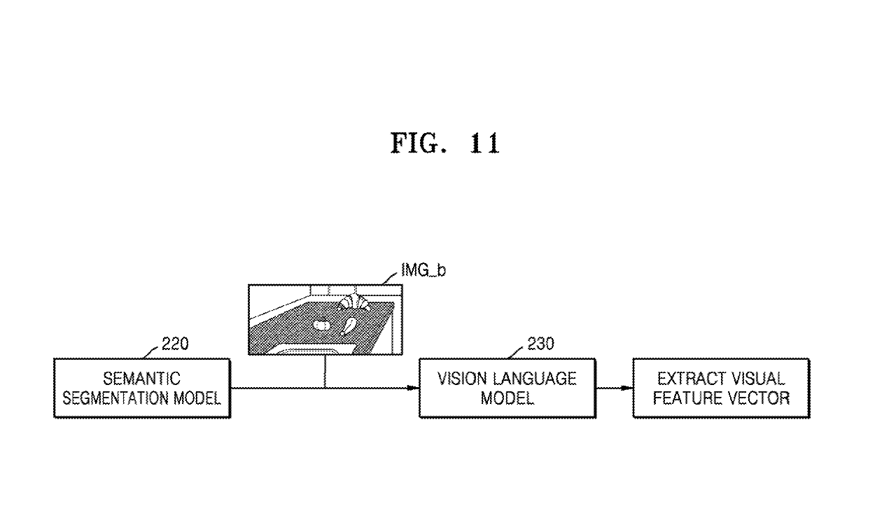

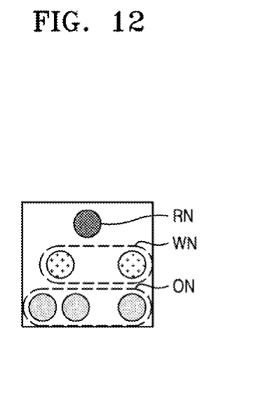

FIG. 9 is a flowchart for schematically explaining an operation of generating workspace nodes, according to an embodiment. FIGS. 10 and 11 are each a diagram for schematically explaining an operation of generating workspace nodes, according to an embodiment. FIG. 12 is a graph for schematically explaining workspace nodes according to an embodiment.

Referring to FIG. 9, the generating of the workspace nodes (operation S300) of FIG. 3 may include inputting the image, the depth information, and the workspace list into a semantic segmentation model (operation S310), extracting pixels and a bounding box, corresponding to each of workspaces (operation S320), and storing workspace information in each of the workspace nodes (operation S330).

In the inputting of the image, the depth information, and the workspace list into the semantic segmentation model (operation S310), workspace labels included in the workspace list may be sequentially input into the semantic segmentation model 220 together with the image IMG.

In the extracting of the pixels and the bounding box, corresponding to each of the workspaces (operation S320), the scene graph generation module 200 may extract pixels corresponding to a workspace label and may generate a bounding box around the corresponding pixels, by using the semantic segmentation model 220. For example, referring to FIG. 10, a workspace label (for example, a countertop) of the workspace list and the image IMG may be input into the semantic segmentation model 220, and the semantic segmentation model 220 may extract pixels corresponding to the countertop from the image IMG and generate a bounding box around the extracted pixels. The scene graph generation module 200 may generate a node of the corresponding workspace by using the extracted pixels and the bounding box.

In the storing of the workspace information in each of the workspace nodes (operation S330), the scene graph generation module 200 may store, in each workspace node, the workspace information including visual information and positional information. The visual information may include a visual feature vector for a portion corresponding to a bounding box region of the image IMG.

As shown in FIG. 11, the vision language model 230 may generate a visual feature vector from a portion IMG_b of an image corresponding to a bounding box region (e.g., corresponding to the countertop). The bounding box may be generated using the semantic segmentation model 220, as described above. The visual feature vector may be stored as visual information in the workspace node of the countertop. The positional information may include workspace coordinates based on the world coordinate system.

Finally, each of the workspace nodes may store, as the workspace information, a label of a workspace, the original image IMG, a portion corresponding to a bounding box region of the image IMG, xyxy coordinates of a bounding box, a visual feature vector, a point cloud, workspace coordinates based on the world coordinate system, and a workspace ID.

FIG. 12 shows, as an example, workspace nodes WN included in a scene graph. Referring to FIG. 12, the workspace nodes WN may be located in an intermediate layer between the room node RN and the object nodes ON.

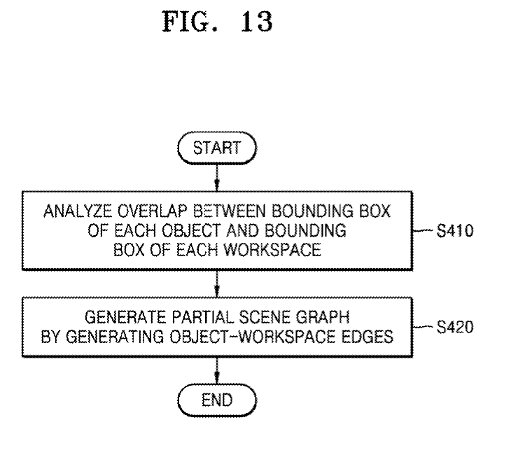

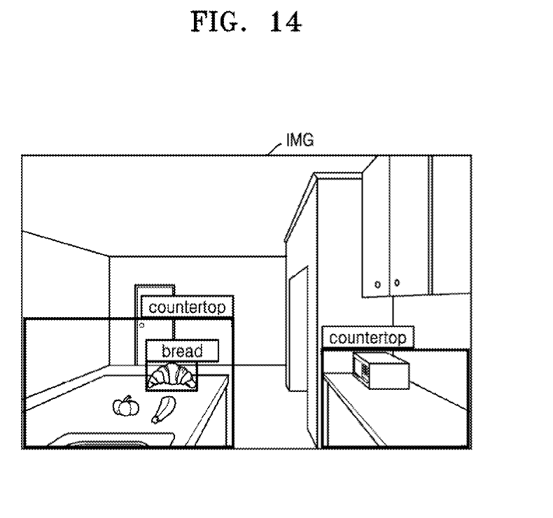

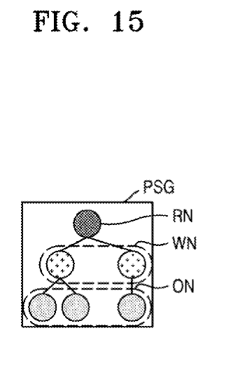

FIG. 13 is a flowchart schematically showing an operation of generating a partial scene graph, according to an embodiment. FIG. 14 is a diagram for schematically explaining an operation of generating an edge between an object and a workspace, according to an embodiment. FIG. 15 is a graph for schematically explaining a partial scene graph according to an embodiment.

Referring to FIG. 13, the generating of the partial scene graph (operation S400) of FIG. 3 may include analyzing a degree of overlap between a bounding box of each object and a bounding box of each workspace (operation S410) and generating the partial scene graph by generating edges that connect the object nodes to the workspace nodes (operation S420).

In the analyzing of the degree of overlap between the bounding box of each object and the bounding box of each workspace (operation S410), the scene graph generation module 200 may sequentially select the object nodes ON and calculate the degree of overlap between the bounding box of each object and bounding boxes of candidate workspace nodes. The candidate workspace nodes may be workspace nodes WN that have labels that are identical to a workspace of an object derived in the generating of the workspace list. The scene graph generation module 200 may determine a workspace having a highest degree of overlap with the bounding box of a corresponding object as the workspace of the corresponding object.

For example, referring to FIG. 14, the image IMG may include two or more workspaces having the same label (for example, countertop) as the workspace of the bread. The scene graph generation module 200 may calculate the degree of overlap between a bounding box of the bread in the image IMG and each of bounding boxes of a first countertop (on a left side of the image) and a second countertop (on a right side of the image), and may determine the first countertop, which has a greater degree of overlap, as the workspace of the bread.

In the generating of the partial scene graph by generating the edges that connect the object nodes to the workspace nodes (operation S420), the scene graph generation module 200 may generate edges between the object nodes ON and the workspace nodes WN by adding each of the object nodes ON as a lower-level node of a corresponding workspace node WN.

Referring to FIG. 15, a partial scene graph PSG generated based on the image IMG obtained at a specific time point and a specific position may have a hierarchical structure including the room node RN, the workspace nodes WN, the object nodes ON, and edges connecting the room node RN, the workspace nodes WN, the object nodes ON. The edges may represent spatial relationships between upper-level nodes and lower-level nodes.

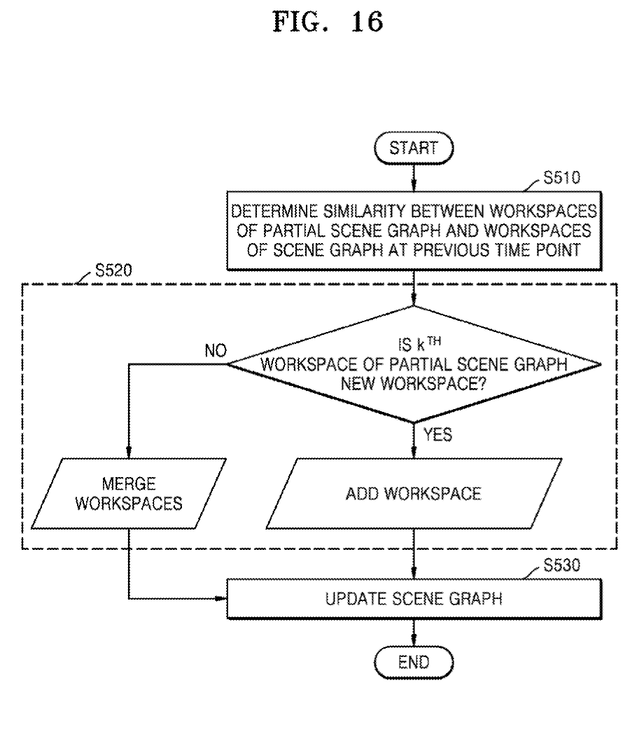

FIG. 16 is a flowchart schematically showing an operation of generating or updating a scene graph, according to an embodiment.

Referring to FIG. 16, the generating or updating of the scene graph (operation S500) of FIG. 3 may include determining a similarity between workspaces of the partial scene graph and workspaces of a scene graph at a previous time point (operation S510), determining whether the workspaces of the partial scene graph are new workspaces (operation S520), and updating the scene graph (operation S530).

In the determining of the similarity between the workspaces of the partial scene graph and the scene graph at the previous time point (operation S510), the scene graph generation module 200 may compare the partial scene graph PSG, which is generated based on the image IMG obtained at a specific time point and a specific position, with the previous scene graph. When the scene graph at the previous time point does not exist, a new scene graph may be generated based on the partial scene graph PSG.

In the determining of whether the workspaces of the partial scene graph are new workspaces (operation S520), the scene graph generation module 200 may determine whether workspaces of the partial scene graph PSG correspond to new workspaces, based on a distance between workspace coordinates of the workspace nodes WN of the partial scene graph PSG with respect to the world coordinate system and workspace coordinates of workspace nodes of the previous scene graph with respect to the world coordinate system.

In the updating of the scene graph (operation S530), the scene graph generation module 200 may determine that when a distance between coordinates of two workspaces is greater than or equal to a threshold value, the two workspaces are sufficiently spaced apart from each other, and thus determine the workspaces of the partial scene graph PSG as new workspaces, and may add workspace nodes of the partial scene graph PSG to the scene graph SG as new workspace nodes. When a distance between coordinates of two workspaces is less than or equal to the threshold value, it may be determined that the two workspaces are the same workspace, and a workspace node of the partial scene graph PSG may be merged with a workspace node of the scene graph SG. The scene graph generation module 200 may update the scene graph by traversing all workspace nodes WN of the partial scene graph PSG.

According to an embodiment, the generated scene graph SG may be a three-dimensional scene graph including an RGB image and depth information, and may include object nodes as lowest-level nodes, and workspace nodes as intermediate-level nodes that include the object nodes as lower-level nodes. Therefore, by providing the mobile manipulator system 1 with detailed information that reflects relationships between objects and workspaces by using the scene graph SG, it is possible to establish and execute task plans for complex and/or abstract user commands.

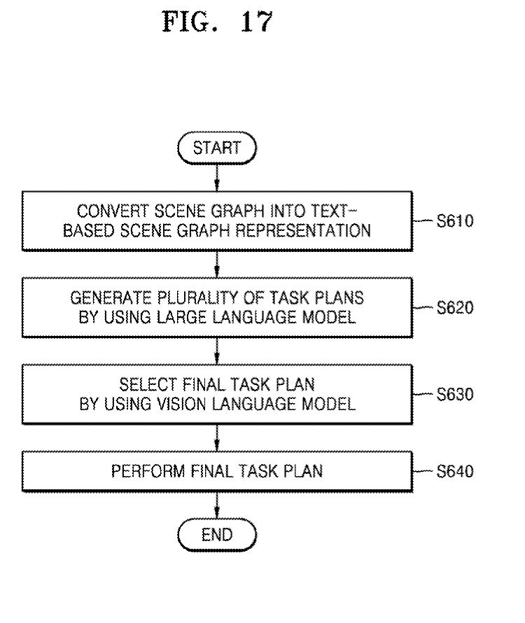

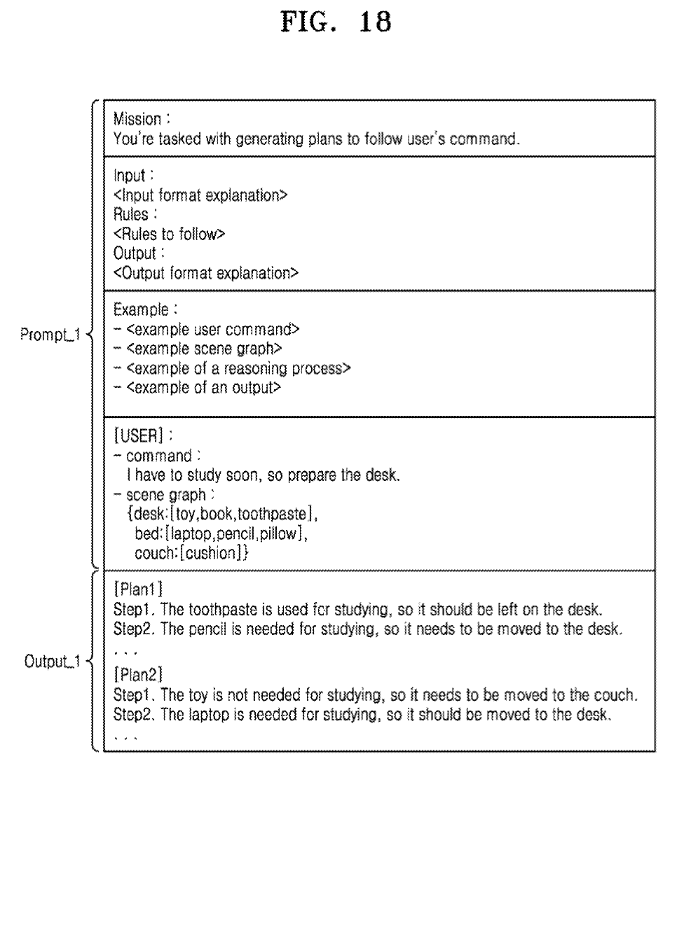

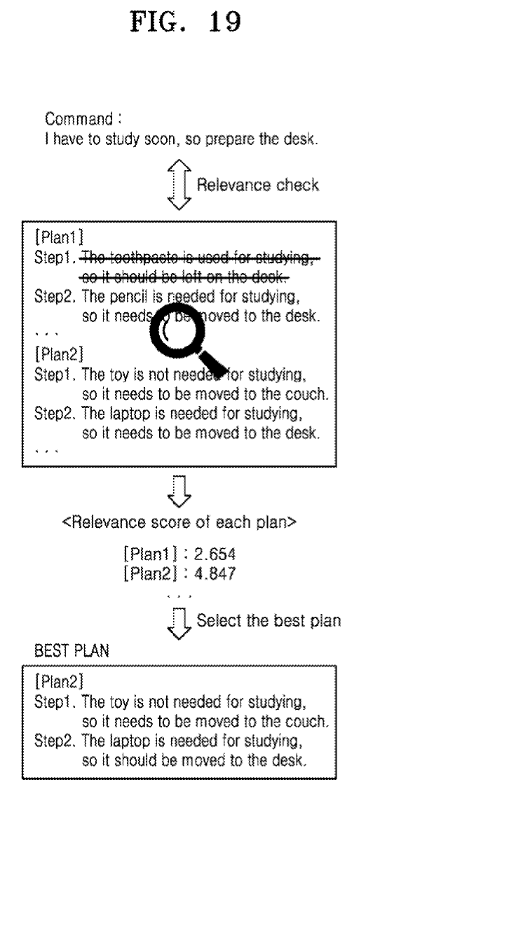

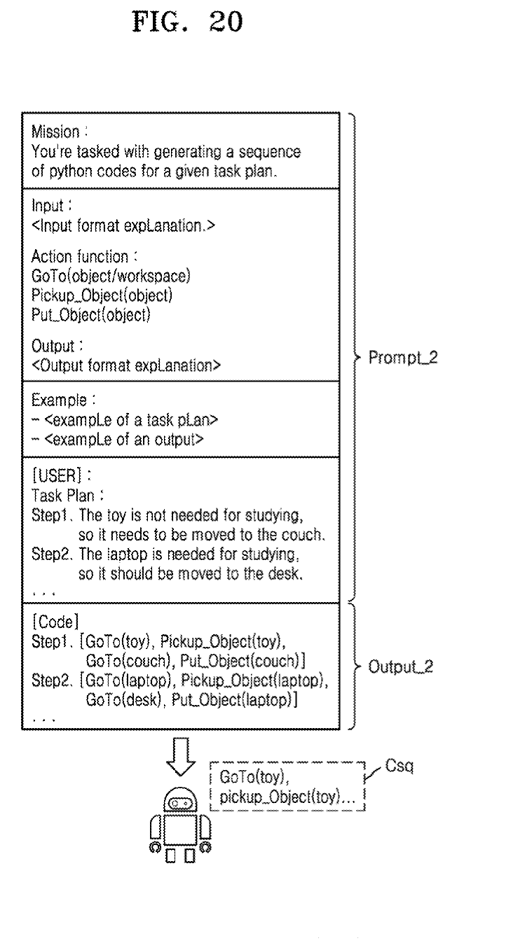

FIG. 17 is a flowchart schematically showing an operation of a task plan generation module, according to an embodiment. FIG. 18 is a diagram schematically explaining an operation of generating a plurality of task plans by using a large language model, according to an embodiment. FIG. 19 is a diagram for schematically explaining an operation of selecting a final task plan, according to an embodiment. FIG. 20 is a diagram schematically explaining an operation of performing a final task plan, according to an embodiment.

FIGS. 18-20 each show, as an example, an operation of a task plan generation module, and the disclosure is not limited to the specific examples disclosed herein, and formats of prompts and/or outputs may be modified in various ways as needed.

Referring to FIG. 17, an operation of the task plan generation module 300 may include converting a scene graph into a text-based scene graph representation (operation S610), generating a plurality of task plans by using a large language model (operation S620), selecting a final task plan by using a vision language model (operation S630), and performing the final task plan (operation S640).

In the converting of the scene graph into the text-based scene graph representation (operation S610), the task plan generation module 300 may convert the scene graph SG into a text format. Relationships between workspace nodes and object nodes may be converted into a text-based scene graph representation in a form of a Python dictionary, that includes an ID of each of workspaces and IDs of object nodes belonging to each workspace.

In the generating of the plurality of task plans by using the large language model (operation S620), the task plan generation module 300 may generate the plurality of task plans by inputting the text-based scene graph representation and the user command CMD into the large language model 310. Each of the task plans may include various sub-plans for performing the user command CMD, and each of the sub-plans may be expressed as a natural language sentence.

Referring to FIG. 18, a first prompt Prompt_1 may be input to the large language model 310, and a first output Output_1 including a plurality of task plans may be output. The first prompt Prompt_1 may include a text-based scene graph representation and the user command CMD expressed as a natural language sentence. For example, in the text-based scene graph representation, inclusion relationships between workspaces, such as a desk, a bed, and a couch, and objects, such as a toy, a book, and a toothpaste, may be defined in a form of a Python dictionary.

The first output Output_1 may include a plurality of task plans Plan1, Plan2, etc. Each of the task plans may include sub-plans Step1, Step2, etc. that include natural language sentences.

In the selecting of the final task plan by using the vision language model (operation S630), the task plan generation module 300 may quantitatively calculate a relevance score of each of the plurality of task plans with respect to the user command CMD and may select the final task plan based on the relevance score, by using the vision language model 320.

First, the task plan generation module 300 may extract a text feature vector for each of sub-plans including natural language sentences and a text feature vector for the user command CMD, by using the vision language model 320. Afterwards, a relevance score of each of the sub-plans with respect to the user command CMD may be calculated based on a cosine similarity between the text feature vector for each of the sub-plans and the text feature vector for the user command CMD. Sub-plans having relevance scores less than a threshold value among the sub-plans may be determined to have low relevance to the user command CMD and thus may be removed.

The relevance score of each of the plurality of task plans with respect to the user command CMD may be calculated by summing cosine similarities of the remaining sub-plans. The task plan generation module 300 may select, as the final task plan, a task plan having the highest relevance score among the plurality of task plans.

Referring to FIG. 19, the task plan generation module 300 may calculate relevance scores of the plurality of task plans Plan1, Plan2, etc. with respect to the user command CMD: “I need to study soon, so prepare the desk.” The first task plan Plan1 may include sub-plans such as “The toothpaste is used for studying, so it should be left on the desk”, “The pencil is needed for studying, so it needs to be moved to the desk”, etc., and the second task plan Plan2 may include sub-plans such as “The toy is not needed for studying, so it needs to be moved to the couch”, “The laptop is needed for studying, so it needs to be moved to the desk”, etc. Relevance of each of the sub-plans with respect to the user command CMD may be quantitatively calculated to remove sub-plans having relevance scores less than a threshold value. Afterwards, cosine similarities of the remaining sub-plans in each of the task plans may be summed to calculate the relevance score of each of the task plans with respect to the user command CMD. For example, the task plan generation module 300 may select, as the final task plan, the second task plan Plan2 having the highest relevance score.

In the performing of the final task plan (operation S640), the task plan generation module 300 may convert the final task plan into the code sequence CSq of robot control functions by using the large language model 310, and the manipulator 30 may operate according to the code sequence CSq.

Each of the robot control functions may have a form of an action (object/workspace), and each function may perform a specific action on a given object and/or workspace. The robot control functions may have built-in functions such as path planning, operation planning, etc.

Referring to FIG. 20, a second prompt Prompt_2 may be input to the large language model 310, and the code sequence CSq expressed as robot control functions may be output. The second prompt Prompt_2 may include the user command CMD expressed as a natural language sentence, robot control functions, and a final task plan including sub-plans expressed as natural language sentences.

A second output Output_2 may include the code sequence CSq of the final task plan including the sub-plans converted into the robot control functions. The code sequence CSq may be transmitted to the manipulator 30, and a robot may perform a task according to the user command CMD.

An intelligent robot including the mobile manipulator system 1 according to embodiments may autonomously recognize the surrounding environment and plan and execute a task in response to a user’s abstract natural language command without additional user intervention. Accordingly, the intelligent robot may autonomously process a wide range of tasks according to a user’s various instructions, even in complex and dynamic environments.

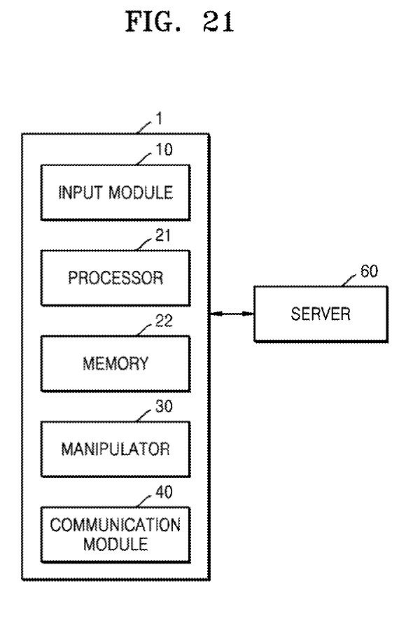

FIG. 21 is a block diagram schematically showing a mobile manipulator system according to an embodiment.

Referring to FIG. 21, the mobile manipulator system 1 may include the input module 10, at least one processor (hereinafter, processor) 21, at least one memory (hereinafter, memory) 23, the manipulator 30, and a communication module 40. According to an embodiment, the mobile manipulator system 1 may not include at least one of the aforementioned components and/or may further include one or more other components. According to an embodiment, some of the aforementioned components may be integrated into another component.

The processor 21 may execute software to control at least one other component (for example, hardware and/or software component) of the mobile manipulator system 1 and perform various data processing or computations. According to an embodiment, as at least part of data processing or computations, the processor 21 may store a command or data, which is received from another component (for example, the input module 10 or the communication module 40), in the memory 23, process the command or data stored in the memory 23, and store a result in the memory 23.

The processor 21 may include at least one of a central processing unit (CPU) or an application processor (AP). The processor 21 may additionally or alternatively include at least one of a graphics processing unit, a communication processor, or an image signal processor. The processor 21 may additionally or alternatively include a neural processing unit. The neural network processing unit may be a processor specialized in processing an artificial intelligence model, and the artificial intelligence model may be created through machine learning. The artificial intelligence model may include a plurality of artificial neural network layers. An artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, and a combination of two or more thereof, but is not limited to the aforementioned examples. The artificial intelligence model may a hardware architecture, and may additionally or alternatively include a software architecture. At least two of the processing units and the processors may be implemented as a single integrated component (for example, a single chip) or may respectively be implemented as separate components (for example, a plurality of chips).

The memory 23 may store various data used by at least one component of the mobile manipulator system 1, as well as input data or output data for commands related thereto. The memory 23 may include at least one of a volatile memory or a non-volatile memory.

The task plan module 20 may be implemented through the processor 21 and the memory 23. In an embodiment, the memory 23 may store, for each of the scene graph generation module 200 and the task plan generation module 300, program code, related data, trained model parameters, and/or prompts for specific tasks. During operations of the scene graph generation module 200 and the task plan generation module 300, the processor 21 may fetch and load corresponding program code and relevant information from the memory 23, and perform computations based thereon to generate a task plan according to the user command CMD.

The input module 10 may receive commands and/or data, which are to be used in the mobile manipulator system 1, from a user, an external electronic apparatus, and/or the server 60. The input module 10 may include, for example but not limited to, a microphone, a mouse, and/or a keyboard. Additionally or alternatively, the input module 10 may include a touch input means and/or a mechanical input means, such as a button, a dome switch, a jog wheel, a jog switch, etc.

The manipulator 30 may be included in the mobile manipulator system 1, and may perform various physical tasks such as grasping, moving, and/or manipulating a target object according to the code sequence CSq output from the processor 21. The manipulator 30 may generally include a plurality of links, a joint, and an end-effector.

In addition, to enable changing of its working position, the manipulator 30 may include, or be integrated with, mobility means such as driven wheels, endless track-type treads, and/or a rail system that supports linear movement along a designated path. Therefore, the manipulator 30 may not be limited to a fixed position and may perform required tasks at various points within a complex and/or wide workspace.

The communication module 40 may support establishing a communication channel between the mobile manipulator system 1 and an external electronic apparatus and/or a server, and performing communication through the established communication channel. The communication module 40 may include any one of or both a wireless communication module and a wired communication module. The wireless communication module may include, for example but not limited to, a cellular communication module, a short-range wireless communication module, or a global navigation satellite system (GNSS) communication module, and the wired communication module may include, for example but not limited to, a local area network (LAN) communication module or a power line communication module. The communication module 40 may transmit and receive a wireless signal over an Internet network by using, for example but not limited to, at least one of wireless LAN (WLAN), wireless-fidelity (Wi-Fi), Wi-Fi Direct, or digital living network alliance (DLNA) technologies. In addition, the communication module 40 may support short-range communication by using, for example but not limited to, at least one of Bluetooth™, radio frequency identification (RFID), infrared data association (IrDA), ultra wideband (UWB), ZigBee, near-field communication (NFC), Wi-Fi, Wi-Fi Direct, or wireless universal serial bus (wireless USB) technology.

The mobile manipulator system 1 may be configured to bidirectionally transmit and receive data to and from the server 60 through the communication module 40, either continuously or as needed. In an embodiment, at least a portion of an operation of the task plan module 20 may be executed using the server 60. However, the disclosure is not limited thereto, and the operation of the task plan module 20 may also be performed independently only by a local computing device. In addition, through a communication interface with the server 60, software and/or firmware components of the mobile manipulator system 1 may be updated to latest versions, and/or new applications and algorithms for enhancing or expanding system functionality may be downloaded and installed.

According to an embodiment, a task plan generation method by which a mobile manipulator autonomously generates and performs a task plan even based on an abstract user command, and a mobile manipulator system using the same may be provided. However, the scope of the disclosure is not limited thereto.

At least one of the components, elements, modules or units (collectively “components”) represented by a block in the drawings and/or described in the specification, may be embodied as various numbers of hardware, software and/or firmware structures that execute respective functions described above, according to one or more example embodiments. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above example embodiments may be implemented in algorithms that execute on one or more processors. Furthermore, the components represented by a block or processing steps may employ any number of related art techniques for electronics configuration, signal processing and/or control, data processing and the like.

Various components according to embodiments of the disclosure may be implemented by memory storing instructions and one or more processors configured to execute the instructions. The one or more processors may include one or more of a central processing unit (CPU), a graphics processing unit (GPU), an accelerated processing unit (APU), a many integrated core (MIC), a field-programmable gate array (FPGA), a digital signal processor (DSP), a neural processing unit (NPU), a hardware accelerator, or a machine learning accelerator. The one or more processors are able to perform control of any one or any combination of the other components of a computing device, and/or perform an operation or data processing relating to communication. The one or more processors execute one or more programs stored in a memory.

The one or more processors may be implemented as one or more multi-core processors that include one or more cores (e.g., homogeneous multi-cores or heterogeneous multi-cores). When a plurality of cores are included in a processor, each of the cores includes a cache memory, and a common cache shared by the cores may be included in the processor. Each of the cores may independently read and execute program instructions or each of the cores may read and execute one or more portions of program instructions.

In embodiments of the disclosure, a processor may refer to a system-on-a-chip (SoC) in which one or more cores and other electronic components are integrated, a single core processor, a multicore processor, or a core included in the single core processor or the multicore processor, wherein the core may be implemented as a CPU, a GPU, an APU, an MIC, an FPGA, a DSP, an NPU, a hardware accelerator, or a machine learning accelerator, but the embodiments of the disclosure are not limited thereto.

It should be understood that example embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and their equivalents.

What is claimed is:

1. A task plan generation method for a mobile manipulator, the task plan generation method comprising:
obtaining an image, depth information, and a user command from an input module;
generating a plurality of task plans, based on the image, the depth information, and the user command, a task plan of the plurality of task plans comprising sub-plans;
calculating relevance scores of the plurality of task plans with respect to the user command; and
selecting a final task plan from among the plurality of task plans based on the relevance scores.

2. The task plan generation method of claim 1, wherein the generating the plurality of task plans comprises:
generating a scene graph based on the image and the depth information; and
generating the plurality of task plans by using a large language model, based on the scene graph and the user command.

3. The task plan generation method of claim 2, wherein the generating the scene graph comprises:
generating at least one object node based on the image and the depth information;
obtaining a workspace list for the at least one object node;
generating at least one workspace node based on the workspace list;
generating a partial scene graph comprising the at least one object node, the at least one workspace node, and at least one edge that connects the at least one object node to the at least one workspace node; and
generating the scene graph by comparing the partial scene graph with a previous scene graph.

4. The task plan generation method of claim 3, wherein the obtaining the workspace list comprises:
inputting an object detection image and a question prompt into a vision language model; and
generating the workspace list based on an output from the vision language model.

5. The task plan generation method of claim 4, wherein the generating the at least one workspace node comprises:
inputting the image, the depth information, and the workspace list into a semantic segmentation model;
extracting at least one pixel and a bounding box, corresponding to a workspace of at least one workspace included in the workspace list, to generate a corresponding workspace node; and
storing workspace information in the corresponding workspace node.

6. The task plan generation method of claim 3, wherein the generating the partial scene graph comprises:
obtaining a degree of overlap between a bounding box of the at least one object node and a bounding box of the at least one workspace node; and
generating the at least one edge that connects the at least one object node to the at least one workspace node based on the degree of overlap.

7. The task plan generation method of claim 2, wherein the generating the plurality of task plans comprises:
converting the scene graph into a text-based scene graph representation; and
generating the plurality of task plans by using the large language model, based on the text-based scene graph representation and the user command.

8. The task plan generation method of claim 2, wherein the calculating the relevance scores comprises calculating a relevance score of the task plan by:
calculating a relevance score of a sub-plan of the sub-plans, based on a cosine similarity between a text feature vector for the sub-plan and a text feature vector for the user command, by using a vision language model;
removing at least one sub-plan having a relevance score less than a threshold value; and
summing at least one relevance score of at least one remaining sub-plan of the task plan.

9. The task plan generation method of claim 2, further comprising converting sub-plans of the final task plan into a sequence of robot control functions by using the large language model.

10. A mobile manipulator system comprising:
an input module configured to obtain an image, depth information, and a user command;
a task plan module configured to:
generate a plurality of task plans, based on the image, the depth information, and the user command, a task plan of the plurality of task plans comprising sub-plans;
calculate relevance scores of the plurality of task plans with respect to the user command; and
select a final task plan from among the plurality of task plans based on the relevance scores; and
a manipulator configured to perform the final task plan.

11. The mobile manipulator system of claim 10, wherein the task plan module comprises:
a scene graph generation module configured to generate a scene graph based on the image and the depth information; and
a task plan generation module configured to generate the plurality of task plans based on the scene graph and the user command and select the final task plan from among the plurality of task plans.

12. The mobile manipulator system of claim 11, wherein the scene graph generation module comprises:
an object detection model configured to generate at least one object node based on the image and the depth information;
a vision language model configured to generate a workspace list for the at least one object node and generate at least one visual feature vector for at least one workspace included in the workspace list; and
a semantic segmentation model configured to extract at least one pixel corresponding to the at least one workspace, based on the workspace list.

13. The mobile manipulator system of claim 12, wherein the vision language model is configured to determine whether to merge two or more object nodes having a same name, based on at least one of a visual similarity or a positional similarity between the two or more object nodes.

14. The mobile manipulator system of claim 13, wherein the vision language model is configured to generate the workspace list by recognizing a workspace for at least one object based on a question prompt and an object detection image generated by the object detection model.

15. The mobile manipulator system of claim 12, wherein the scene graph generation module is configured to generate at least one workspace node respectively corresponding to the at least one workspace,
generate a partial scene graph comprising the at least one object node, the at least one workspace node, and at least one edge that connects the at least one object node to the at least one workspace node, and
generate a new scene graph or update a previous scene graph, by using the partial scene graph.

16. The mobile manipulator system of claim 15, wherein the scene graph generation module is configured to:
obtain a degree of overlap between a bounding box of the at least one object node and a bounding box of the at least one workspace node, and
generate the at least one edge that connects the at least one object node to the at least one workspace node based on the degree of overlap.

17. The mobile manipulator system of claim 11, wherein the task plan generation module comprises:
a large language model configured to generate the plurality of task plans based on the user command and the scene graph and convert sub-plans of the final task plan into a sequence of robot control functions; and
a vision language model configured to calculate the relevance scores of the plurality of task plans with respect to the user command.

18. The mobile manipulator system of claim 17, wherein the vision language model is configured to calculate a relevance score of the task plan by:
calculating a sub-plan of the sub-plans of the task plan, based on a cosine similarity between a text feature vector for the sub-plan and a text feature vector for the user command;
removing at least one sub-plan having a relevance score less than a threshold value; and
summing at least one relevance score of at least one remaining sub-plan of the task plan.

19. The mobile manipulator system of claim 18, wherein the task plan generation module is configured to select, as the final task plan, a task plan having a highest relevance score among the plurality of task plans.

20. The mobile manipulator system of claim 17, wherein the large language model is configured to receive a text-based scene graph representation, which is obtained by converting the scene graph.
